(19) United States
(12) Patent Application Publication
(10) Pub. No.: US 2002/0163109 A1
(43) Pub. Date: Nov. 7, 2002

(54) Conformal firing of ceramic radomes

(75) Inventors: Kevin W. Kirby, Calabasas Hills, CA (US); Anthony T. Jankiewicz, Seattle, WA (US); James M. Lyon, Tucson, AZ (US); Joseph W. Barber, Newbury Port, MA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(73) Assignee: RAYTHEON COMPANY

(21) Appl. No.: 10/108,323

(22) Filed: Mar. 26, 2002

Related U.S. Application Data
(60) Provisional application No. 60/281,215, filed on Apr. 3, 2001.

(51) Int. Cl. C04B 33/32

(52) U.S. Cl. 264/633; 264/671; 264/672; 264/669; 264/670

(57) ABSTRACT

A procedure is provided for bringing an incompletely densified cast radome to a desired final or near final shape through the use of one or more conformal tools during a high temperature firing operation. A conformal firing tool is defined in this case as a mandrel or mold made from a high temperature material, such as a graphite composite, that represents the desired shape of the finished radome. The process consists of firing the cast radome body over a mandrel, or inside a mold, or in combination with the two, such that the tools impart a desired dimensionality to the cast part as it densities and flows at high temperature.

### CROSS-REFERENCE TO RELATED APPLICATION

The present application is a non-provisional application and claims priority from provisional application Serial No. 60/281,215, filed on Apr. 3, 2001.

### BACKGROUND OF THE INVENTION

1. Field of the Invention

This invention generally relates to radomes for missiles and the like and, more particularly, to a method of forming a radome to a near final dimension without machining through use of conformal firing tools.

2. Discussion

Radomes provide an efficient aerodynamic shape for the leading end of a missile or the like. Radomes are also designed to serve as a barrier for protecting underlying guidance electronics and detectors from impact and high temperature related failures. Consequently, radome materials must have a high hardness and strength to endure flight conditions. In addition, radomes must be electrically transparent windows which requires precise wall thickness and composition to avoid reflective and absorptive radio frequency transmission losses respectively.

The currently preferred material for radio frequency type radomes is ceramics. While the raw ceramic materials and synthesis procedures are generally inexpensive, the finishing steps that bring the radome to the final dimensions and precise tolerance typically include careful and expensive machining. It is not uncommon for 70% of the entire radome cost to be associated with the required machining operations.

Prior art ceramic radomes (such as, for example, pyroceram type radomes) are cast as a glass and converted to a crystalline ceramic in a methodical firing and annealing procedure. Because of the nature of the process and the characteristics of the material, the as-cast radome body has a wall dimension approaching twice the value of the desired finished product. To obtain the desired final precision wall thickness, the ascast radome body must undergo expensive machining operations.

Therefore, it would be desirable to provide firing procedures that produce a finished part having as close to final dimensions as possible such that required machining operations are minimized.

### SUMMARY OF THE INVENTION

The above and other objects are provided by a procedure for bringing an incompletely densified cast radome to a desired final or near final shape through the use of one or more conformal tools during a high temperature firing operation. A conformal firing tool is defined in this case as a mandrel or mold made from a high temperature material that represents the desired shape of the finished radome. Such a high temperature material may have a coefficient of expansion that is nearly the same as that of the radome or somewhat higher. The process consists of firing the cast radome body over the mandrel, or inside the mold, or in combination with the two, such that the tools impart a desired dimensionality to the cast part as it densities and flows at high temperature.

### BRIEF DESCRIPTION OF THE DRAWINGS

In order to appreciate the manner in which the advantages and objects of the invention are obtained, a more particular description of the invention will be rendered by reference to specific embodiments thereof which are illustrated in the appended drawings. Understanding that these drawings only depict preferred embodiments of the present invention and are not therefore to be considered limiting in scope, the invention will be described and explained with additional specificity and detail through the use of the accompanying drawings in which:

FIG. 1 is a perspective view of a missile having a radome associated therewith formed in accordance with the teachings of the present invention;

FIG. 2 is a more detailed perspective view of the radome of FIG. 1;

FIG. 3 is a perspective view of an as-cast radome and a mandrel used for shaping an inner surface thereof to a final dimension during a firing operation;

FIG. 4 is a perspective view of an as-cast radome and a mold for shaping an outer surface thereof to a final dimension during a firing operation; and

FIG. 5 is a perspective view of an as-cast radome, mandrel and mold for shaping the inner and outer surfaces thereof to a final dimension during a firing operation.

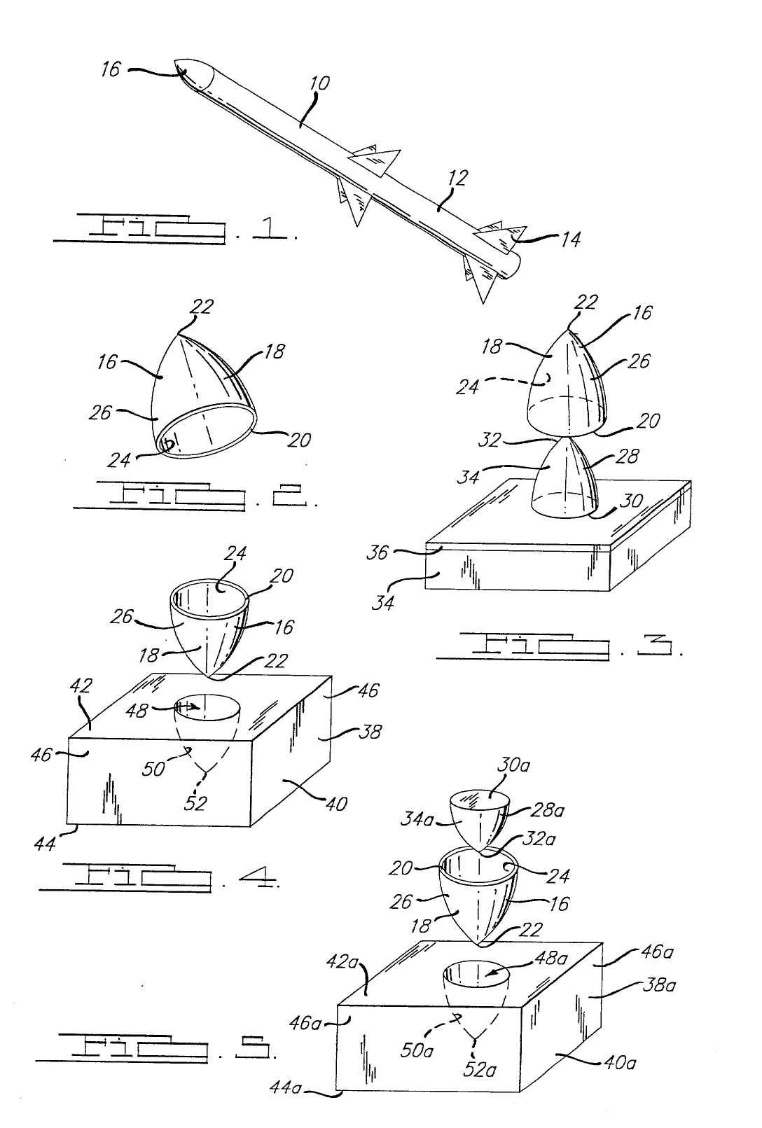

### DETAILED DESCRIPTION OF THE PREFERRED EMBODIMENTS

The present invention is directed towards a method for forming an as-cast radome to a final or near final form through the use of a mandrel, mold, or the combination of the two during a firing operation. According to the present invention, the as-cast radome shrinks during the firing operation to conform to the shape of the mandrel, mold or both. As such, the post fired radome is dimensioned extremely close to the desired final form and subsequently required machining operations, and the cost associated therewith, are minimized.

In order for the radome to adequately perform in its intended environment, the material comprising the radome must possess a high hardness and strength to endure flight conditions. The radome must also possess a precise wall thickness and composition to avoid reflective and absorptive radio frequency transmission losses respectively. Ceramics such as pyroceram have been found to be particularly well suited for this application.

Turning now to the drawing figures, a missile 10 such as an AMRAAM, Standard Missile, Sparrow or the like is illustrated. The missile 10 includes a body 12, stabilizers 14 and radome 16. The body 12 houses a propulsion system as well as guidance electronics and various detectors (not shown). The radome 16 not only provides an efficient aerodynamic shape for the missile 10, but also protects the underlying guidance electronics and detectors from impact and high temperature related failures. The radome 16 also serves as a transparent radio frequency window for the missile 10.

Referring now to FIG. 2, the radome 16 is illustrated in greater detail. The radome 16 includes a wall 18 terminating at a first end in a circular base 20 and at a second end at a tip 22. The wall 18 may be conically shaped or may have a slight radius of curvature between the base 20 and the tip 22. The wall 18 also includes an inner radial surface 24 and an outer radial surface 26 defining a thickness for the wall 18 therebetween.

In order to produce the radome to its desired final dimensions, conformal firing tools such as those illustrated in FIGS. 3-5 are used during high temperature densification (i.e., firing). The radome 16 is preferably initially formed to a rough shape by a gelcasting process which begins with mixing ceramic powders that represent the composition of the final ceramic body with an organic solution forming a slip or slurry. The slip is then poured into a preform (not shown) representing the general shape of the radome 16 in a casting procedure. The organic constituent of the mixture is then allowed to polymerize (gel), forming a rigid network comprised of the ceramic powder encapsulated in the organic matrix.

After a prescribed drying procedure, the as-cast “green-body” (i.e., prefired or undensified) radome is removed from the preform. Dimensional changes from the as-cast radome to the dried green-body radome are small (2-3 linear %) and uniform, unlike conventional slip-casting processes. A more detailed explanation of a preferred gelcasting process can be found in commonly assigned U.S. Pat. No. 6,083,452, entitled “Near Net-Shape Fabrication of Ceramic Radomes” to Kirby et al., which is hereby incorporated by reference herein. While the conformal firing process described below is particularly well suited for ceramic materials in the above-described system, it should be appreciated that the process is also applicable to materials in other systems, particularly those that have large high temperature creep rates or can be liquid phase sintered.

After the dried green-body radome is removed from the preform, it is fired at approximately 600° C. in air in a separate “non-conformal” procedure to remove the organic constituents. Minimal to no dimensional changes are observed during this firing procedure. It should also be noted that this organic constituent removal step may or may not be required for other ceramic materials to prepare them for the conformal firing procedure described below.

Turning now to FIG. 3, the radome 16 is readied for a first embodiment conformal firing procedure by placing it base 20 down over the top of a conformal mandrel 28. As can be seen, the mandrel 28 includes a base 30, a tip 32, and a final shape imparting surface 34 therebetween. During initial testing, a hollow, graphite mandrel 28 was utilized due to its availability and ease of machining. Due to the difference in the coefficients of thermal expansion for the ceramic radome 16 and the graphite mandrel 28, geometric reliefs (not shown) were added to the mandrel 28 to ease removal of the radome 16 from the mandrel 28 after cooling. It is desirable to have the coefficient of thermal expansion of the mandrel 28 to be as compatible with the coefficient of thermal expansion of the radome 16 as possible. It may also be desirable to form the mandrel 28 of a material which has a higher coefficient of thermal expansion than the radome 16 such that the mandrel 28 will have the proper dimensions at the tuning temperature but will shrink away from the radome 16 upon cooling. As such, easy removal of the radome 16 from the mandrel 28 is facilitated.

The radome 16 is typically not in contact with the mandrel 28 at this stage of the procedure because of the difference in their size. Therefore, the mandrel 28 does not initially provide support for the radome 16. Consequently, the radome 16 is initially supported at its base 20 by other means such as a base plate 35. Preferably, the base plate 35 is lined with a high temperature felt 36 or other similar material.

As the temperature of the radome 16 is ramped up, it begins to shrink in size as a consequence of the densification or sintering of the ceramic material. Eventually, the radome 16 shrinks to the point where it comes into contact with the conformal mandrel 28 over its entire inner surface 24. In the case of ceramic radomes in the SiO₂—Al₂O₃—AlN—Si₃N₄ system, the ceramic material may become soft and able to partially flow at temperatures above 1400° C. At this stage of the firing procedure, the radome 16, and particularly the inner radial surface 24, takes on the dimensions of the final shape imparting surface 34 of the mandrel 28 by conforming to its shape through densification and flow. Consequently, the design of the conformal mandrel 28 is such that it provides support while imparting a shape to the radome 16 during densification and flow so that upon cooling the radome 16 will have the final or near final desired interior dimension. After the radome 16 has cooled, it is removed from the mandrel 28 and can be used in its desired application. If desired, the radome 16 may be subject to slight machining to bring it to exact dimensions.

Turning now to FIG. 4, a second embodiment conformal firing procedure will be described. The radome 16 is prepared for the conformal firing procedure of this embodiment by placing it tip 22 down into a conformal mold 38. As can be seen, the mold 38 includes a body 40 having a top surface 42 interconnected with a bottom surface 44 by a plurality of side surfaces 46. Although a generally cubic shaped body 40 is illustrated, one skilled in the art will appreciate that this configuration is merely exemplary of the many configurations that could equally substitute therefore. The mold 38 also includes a cavity 48 formed from the top surface 42 interior of the body 40. The cavity 48 is defined by a shape imparting surface 50 of the body 40 extending from the top surface 42 to a tip 52. Although other materials may be substituted therefore, it is presently preferred to form the mold 38 from a graphite composite.

Since the radome 16 is initially larger than the greatest diameter of the cavity 48 in the conformal mold 38, the radome 16 initially rests only partially therein having its exterior surface 26 impinging upon the top surface 42 at the edge of the cavity 48. As the temperature of the radome 16 is ramped up, it begins to shrink in size as a consequence of the densification or sintering of the ceramic material. Eventually, the radome 16 shrinks to the point where it enters completely into the cavity 48 and contacts the conformal mold 38 about its entire outer radial surface 26. In the case of ceramic radomes in the SiO₂—Al₂O₃—AlN—Si₃N₄ system, the material may become soft and able to partially flow at temperatures above 1400° C. therefor. At this stage of the firing procedure, the radome 16, and particularly the outer radial surface 26, takes on the dimensions of the final shape imparting surface 50 of the mold 38 by conforming to its shape through densification and flow. Consequently, the design of the conformal mold 38 is such that it provides support while imparting a shape to the radome 16 during densification and flow so that upon cooling the radome 16 will have the final or near final desired exterior dimension. After the radome 16 has cooled, it is removed from the mold 38 and can be used in its desired application. If desired, the radome 16 may be subject to slight machining to bring it to exact dimensions.

Referring now to FIG. 5, a third conformal firing procedure combining the advantages of the first and second conformal firing procedures described above is illustrated. Since the radome 16 will eventually support the mandrel 28 during this procedure, the radome 16 is preferably first fired in a non-conformal manner at a temperature sufficient for sintering the radome 16 to thereby impart it with sufficient strength to avoid failure during the conformal firing process. This temperature is preferably at or near 1500° C. for gelcast undensified radomes in the SiO₂—Al₂O₃—AlN—Si₃N₄ system. However, this temperature may vary for other systems and materials.

Thereafter, the third embodiment conformal firing procedure continues with the sintered radome 16 being placed tip 22 down into the conformal mold 38a designed to impart the desired final exterior dimensions to the radome 16 after high temperature firing and cooling to room temperature. The conformal mandrel 28a is also employed during the high temperature firing, occupying the interior volume of the radome 16 in the same tip 32a down orientation. The weight of the mandrel 28a is selected such that at the appropriate temperature, it encourages the ceramic material of the radome 16 to flow and conform to the shape of the exterior conformal mold 38a and interior conformal mandrel 28a. Upon cooling to room temperature, the mandrel 28a is removed from the radome 16 and the radome 16 is removed from the conformal mold 38a with the imparted dimensions from each creating the desired interior and exterior radii and wall thickness of the radome 16.

To achieve conformity within precise tolerances during any of the conformal firing processes described above, information must first be obtained on the thermal expansion characteristics of the radome 16, mandrel 28, and mold 38, as well as the temperature where creep or plastic flow begins, and the rate of the creep or flow as a function of temperature. With this information, calculations are made to determine the time-temperature exposure necessary to achieve full densification and conformity to the shape of the mandrel 28 and/or mold 38. For the case of gelcast undensified radomes in the SiO₂—Al₂O₃—AlN—Si₃N₄ system, a conformal firing time-temperature regiment of ramping up the temperature of the radome 16 at 5° C./minute to 1650° C. in nitrogen, holding the temperature of the radome 16 at 1650° C. for four hours, followed by controlled cooling of the radome 16 to room temperature at no greater than 5° C./minute is preferred. Once the radome 16 has cooled to room temperature, it is separated from the mandrel 28 and/or mold 38 yielding an inner radial surface 24 and/or outer radial surface 26 with the desired dimensions.

Thus, the present invention provides a method for forming a radome for a missile or the like to a desired final dimension during a firing process. The process consists of firing an as-cast radome body over a mandrel, or inside a mold, or in between the two, such that a desired dimensionality is imparted upon the radome as it densifies and flows at high temperature. Advantageously, the requirement for subsequent machining operations, and the expensive costs associated therewith, are minimized by this procedure since the resulting radome is dimensionally near the final desired form.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed is:

1. A method of forming a radome for a missile or the like to a final or near final form during a firing operation comprising:
providing an as-cast radome;
placing said radome adjacent at least one conformal firing tool such that a surface of said radome thereof is adjacent a final shape imparting surface of said at least one conformal firing tool; and
controlling a temperature of said radome such that said radome densities and flows to a point at which said surface conforms to said final shape imparting surface of said at least one conformal firing tool.

2. The method of forming a radome of claim 1 wherein said at least one conformal firing tool further comprises a mold and said surface of said radome further comprises an exterior surface thereof.

3. The method of forming a radome of claim 2 wherein said at least one conformal firing tool further comprises a mandrel and said surface of said radome further comprises an interior surface thereof.

4. The method of forming a radome of claim 1 wherein said at least one conformal firing tool further comprises a mandrel and said surface of said radome further comprises an interior surface thereof.

5. The method of claim 1 wherein said radome comprises a material in the SiO₂—Al₂O₃—AlN—Si₃N₄ system.

6. The method of forming a radome of claim 5 wherein said step of controlling a temperature of said radome further comprises:
raising a temperature of said radome from room temperature to about 1650° C. at a rate of about 5° C./minute;
holding said temperature of said radome at about 1650° C. for approximately four hours; and
lowering said temperature of said radome to room temperature at a rate of about 5° C./minute.

7. The method of forming a radome of claim 1 wherein said radome is initially fired at about 600° C. to remove organic constituents.

8. The method of forming a radome of claim 1 wherein said radome is initially fired at a pre-selected temperature such that said radome sinters.

9. The method of forming a radome of claim 8 wherein said pre-selected temperature is approximately equal to 1500° C.

10. The method of forming a radome of claim 1 wherein said final shape imparting surface of said conformal firing tool corresponds to a final desired shape of an exterior surface of said radome.

11. The method of forming a radome of claim 1 wherein said final shape imparting surface of said conformal firing tool corresponds to a final desired shape of an interior surface of said radome.

12. The method of forming a radome of claim 1 wherein a weight of said conformal firing tool is controlled such that said conformal firing tool imparts a desired thickness to said radome over a given period of time at a known flow rate of a material constituting said radome.

13. The method of forming a radome of claim 1 wherein said as-cast radome further comprises a gelcast type radome.

14. A method of forming a radome for a missile or the like comprising:
providing an as-cast radome having an interior surface and an exterior surface;
placing said radome in a mold such that an exterior surface of said radome is adjacent a final shape imparting surface of said mold; and
controlling a temperature of said radome such that said radome densifies and flows to a point at which said exterior surface conforms to said final shape imparting surface of said mold.

15. The method of forming a radome of claim 14 further comprising:
placing a mandrel adjacent said radome opposite said mold such that said interior surface of said radome is adjacent a final shape imparting surface of said mandrel; and
continuing said step of controlling a temperature of said radome until said interior surface of said radome conforms to said final shape imparting surface of said mandrel and a thickness of said radome between said exterior surface and said interior surface reaches a desired dimension.

16. The method of claim 14 wherein said radome comprises a material in the SiO₂—Al₂O₃—AlN—Si₃N₄ system.

17. The method of forming a radome of claim 16 wherein said step of controlling a temperature of said radome further comprises:
raising a temperature of said radome from room temperature to about 1650° C. at a rate of about 5° C./minute;
holding said temperature of said radome at about 1650° C. for approximately four hours; and
lowering said temperature of said radome to room temperature at a rate of about 5° C./minute.

18. The method of forming a radome of claim 14 wherein said radome is initially fired at approximately 600° C. to remove organic constituents.

19. A method of forming a radome for a missile or the like comprising:
providing an as-cast radome having an interior surface and an exterior surface;
placing a mandrel adjacent said interior surface of said radome such that a final shape imparting surface of said mandrel is adjacent said interior surface; and
controlling a temperature of said radome such that said radome densities and flows to a point at which said interior surface conforms to said final shape imparting surface of said mandrel.

20. The method of forming a radome of claim 19 further comprising:
placing said radome in a mold such that said exterior surface of said radome is adjacent a final shape imparting surface of said mold; and
continuing said step of controlling a temperature of said radome until said exterior surface of said radome conforms to said final shape imparting surface of said mold and a thickness of said radome between said exterior surface and said interior surface reaches a desired dimension.

21. The method of claim 17 wherein said radome comprises a material in the SiO₂—Al₂O₃—AlN—Si₃N₄ system.

22. The method of forming a radome of claim 21 wherein said step of controlling a temperature of said undensified radome further comprises:
raising a temperature of said radome from room temperature to about 1650° C. at a rate of about 5° C./minute;
holding said temperature of said radome at about 1650° C. for approximately four hours; and
lowering said temperature of said radome to room temperature at a rate of about 5° C./minute.

23. The method of forming a radome of claim 19 wherein said radome is initially fired at approximately 600° C. to remove organic constituents.
